(19) United States
(12) Patent Application Publication
(10) Pub. No.: US 2008/0067814 A1
(43) Pub. Date: Mar. 20, 2008

(54) Method and Device for Controlling the Pitch Angles of the Rotor Blades of Wind Power Stations

(75) Inventor: Peter Volkmer, Dresden (DE)

Correspondence Address: HESLIN ROTHENBERG FARLEY & MESITI PC, 5 COLUMBIA CIRCLE, ALBANY, NY, 12203, US

(73) Assignee: IGUS - INNOVATIVE TECHNISCHE SYSTEME GMBH, Dresden (DE)

(21) Appl. No.: 11/576,265

(22) PCT Filed: Oct. 10, 2005
(86) PCT No.: PCT/DE05/01811

§ 371 Date: Jul. 19, 2007

(30) Foreign Application Priority Data
Oct. 9, 2004 (DE) 10 2004 049 530.0

(51) Int. Cl. F03D 9/00

(52) U.S. Cl. 290/44

(57) ABSTRACT

The invention relates to a method and a device for controlling the pitch angles of rotor blades on wind power stations, the pitch angle being controlled to maximize yields and prevent excess loads on the rotor blades. The aim of the invention is to maximize the propulsive power on rotor blades. Said aim is achieved by taking a first measurement of the pressure prevailing on the pressure side (5) and a second measurement of the pressure prevailing on the suction side (6) of a rotor blade (1), determining the difference in pressure between the first and second pressure measurement, and adjusting the pitch angle in accordance with the ratio between the first and second pressure measurement.

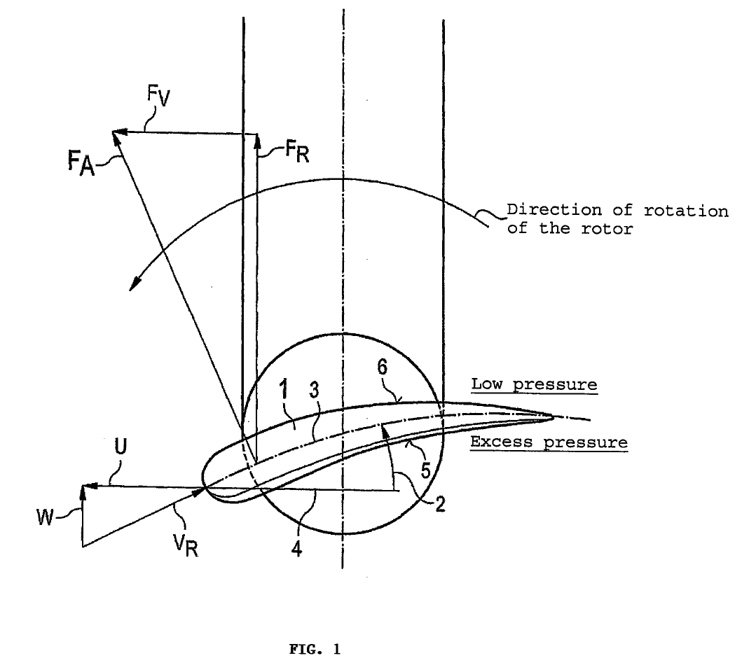

The invention relates to a method for controlling the pitch angles of rotor blades on wind power stations, the pitch angle being controlled to maximize yields and prevent excess loads on the rotor blades.

The invention also relates to a device for controlling the pitch angles of rotor blades on wind power stations, said device having means for adjusting the pitch angles.

In wind power stations, the rotor blades usually have a cross-section resembling that of wing profiles. This cross-section (profile) comprises a concave curvature on the longitudinal side of the cross-section, which forms the suction side of the rotor blade and a substantially convex longitudinal side of the cross-section, which forms the pressure side of the rotor blade. Both the cross-sections enclose the cross-sectional centerline, which accordingly follows the longitudinal direction of the cross-section.

In order to generate a rotation, the rotor blades must receive a force component—the propulsive force or the driving force—which is tangential to the rotational axis of the rotor and which is brought about by an angle taken by the rotor blades in relation to the rotational axis of the rotor, since the lift forces and the propulsive forces are determined therewith. This angle is referred to as the pitch angle or pitch in short, and is usually measured between the cross-sectional centerline and a plumb line in relation to the rotational axis.

It is known that the adjustment of pitch angles of the rotor blades is responsible for the yields achieved using the wind power plant. For this purpose, the adjustment of the pitch angles is controlled by means of characteristics, e.g. depending on or in connection with the wind velocity measured on the nacelle, the speed and/or the torque of the drive shaft and/or the electrical power.

The process of controlling these characteristics is problematic to such effect that it is not found to be the optimal adjustment of the pitch angle for the extremely different wind conditions between the upper and the lower position of the rotor blades particularly as a result of their considerable length in large wind power stations since the substantial measured variable “wind velocity” is measured only at selected points on the nacelle.

It is the object of the invention to maximize the propulsive force on rotor blades and prevent excess loads on the rotor blades.

This objective is attained by means of a method according to claim 1. The dependent claims 2 to 8 outline advantageous variants of the inventive method.

The objective of the invention is also attained by means of a device having the characteristics defined in claim 9. The dependent clauses 10 and 11 outline an advantageous embodiment of the invention.

According to the solution proposed by the inventive method to attain the objective of the invention, a first measurement of the pressure prevailing on the pressure side (excess pressure measurement) and a second measurement of the pressure prevailing on the suction side of a rotor blade (low pressure measurement) is taken. At least one ratio between the first and the second pressure measurement is determined. This ratio can be determined in various ways, for example, in the form of a pressure differential or as a time derivative thereof, as has been explained further below. Then the pitch angle is adjusted by means of a control function, which is functionally dependent on the ratio formed between the first and second pressure measurement. It is thus possible to increase the efficiency of the wind power station and/or to prevent excess loads on the rotor blades by means of adjusting the pitch angles.

One possibility is to express the ratio between the first and second pressure measurement in the form of a pressure differential.

It is particularly possible to form the ratio between the absolute values of the first and second pressure measurement.

The time course of the ratio for the behavior of the rotor blades can be significant, because the pressure ratios can change, for example, during a rotation of the rotor blade. For this reason, the control function is functionally dependent on the time course of the at least one ratio. It is thus possible, for example, to optimally adapt the pitch angle to a ratio of this type.

For example, for preventing the excess loads on rotor blades, the magnitude of the time course, i.e., of the time derivative of the at least one ratio, can represent a significant variable. In this case, it is expedient if the control function is functionally dependent on the magnitude of the time course of the at least one ratio.

Particularly for optimizing the efficiency of the wind power station, it is expedient if the pitch angle is adjusted until a pressure differential sets in which corresponds to the maximum lift.

The invention also enables the prevention of excess loads on the rotor blades. Here it is particularly possible to react in a timely manner in the case of possible excess loads on the rotor blades without requiring a transgression of the load limits. This is possible expediently by adjusting the pitch angles when an excess load occurs on the rotor blades so as to maintain the permissible load.

It is further expedient that the first and second pressure measurement (excess pressure and low pressure measurement) are performed multiple times on several measuring points of the rotor blade. Any local measurement errors or local particularities of a measuring point can thus be determined or even eliminated. It is thus also possible to establish the occurrence of local peculiarities on the rotor blade.

According to the solution proposed by the inventive device to attain the objective of the invention, at least two pressure-measuring points are disposed on a rotor blade, which pressure-measuring points are connected by means of a measuring and control unit to the means for adjusting the pitch angles. These pressure-measuring points can be located at the pressure side and at the suction side of the rotor blade or can at least be connected to these sides of the rotor blade.

A measuring point expediently comprises a channel passing through the shell of the rotor blade and a pressure transmitter, which is disposed on the inner side of the rotor blade at the internal opening of the respective channel. It is thus possible to arrange the pressure transmitter on the inner side of the rotor blade where it is easily accessible, for example for maintenance purposes.

Alternatively, a measuring point advantageously comprises a channel passing through the shell of the rotor blade, a hose connected to said channel and a pressure transmitter disposed at any location in the rotor blade. It is thus possible to arrange the pressure transmitter at those locations, which can be accessed particularly easily in the rotor blade.

The invention is explained below in detail with reference to a drawing, which shows the individual effective physical variables.

Flow ratios resulting from the incident flow corresponding to the pitch 2 of the rotor blade 1, between the cross-sectional centerline 3 and a plumb line to the rotational axis 4, are essential to the lifting forces F_{A} and thus to the driving forces or propulsive forces F_{V} on the rotor blade 1. A radial force component F_{R} results from the propulsive forces F_{V} and the lifting forces F_{A}. The flow ratios and thus the lifting forces F_{A} can be evaluated effectively by measuring the excess pressure on the pressure side 5 and the low pressure on the suction side 6 on the rotor blade 1.

The triangle shown in the drawing indicates the ratio between the wind velocity W, velocity of circulation U and the resulting velocity V_{R}.

If the pitch 2 of the rotor blade 1 is controlled in such a way using the measurement of the flow ratios by measuring the pressure ratios according to the invention, that the rotor blade 1 shows an aerodynamically optimal effect, then it is possible to achieve a maximum yield using aerodynamic effect control directly. This maximum yield is better than controlling the pitch indirectly by means of families of characteristics and better than measuring the wind on the nacelle, which is not characteristic for rotor blades.

The pressure distribution is measured by means of several pressure-measuring points (not illustrated) that are distributed over the surface of the rotor blades 1.

The simplest embodiment of the measuring points is as follows:

Small channels passing through the shell of the rotor blade 1 are inserted along the rotor blade 1 on the pressure side 5 and on the suction side 6. The external pressure is measured using attached pressure transmitters on the inner side of the shell of the rotor blade 1.

Corresponding to the profiles used for the rotor blade 1 and based on, for example, experimental or computed values, the required optimal pressure ratios for the control algorithm according to the invention are used for achieving maximum yields and also limit pressure values in which additional variables such as, e.g., the wind velocity and the speed are contained.

### LIST OF REFERENCE SYMBOLS

1 Rotor blade
2 Pitch
3 Cross-sectional center line
4 Plumb line to the rotational axis
5 Pressure side
6 Suction side
F_{A} Lifting force
F_{V} Driving force or propulsive force
F_{R} Radial force component
W Wind velocity
U Velocity of circulation
V_{R} Resulting velocity

1. Method for controlling the pitch angles of rotor blades on wind power stations, the pitch angle being controlled to maximize yields and prevent excess loads on the rotor blades, said method comprising a first measurement of the pressure prevailing on the pressure side (excess pressure measurement) and a second measurement of the pressure prevailing on the suction side of a rotor blade (low pressure measurement) is taken, at least one ratio between the first and the second pressure measurement is determined and the pitch angle is adjusted by means of a control function, which is functionally dependent on the ratio formed between the first and second pressure measurement.

2. Method according to claim 1, wherein the ratio between the first and the second pressure measurement is expressed in the form of a pressure differential.

3. Method according to claim 1 or 2, wherein the ratio is formed between the absolute values of the first and the second pressure measurement.

4. Method according to claim 1 to 3, wherein the control function is functionally dependent on the time course of the at least one ratio.

5. Method according to claim 1 to 3, wherein the control function is functionally dependent on the magnitude of the time course, i.e., on the time derivative of the at least one ratio.

6. Method according to claims 1 to 5, wherein the pitch angle is adjusted until a difference in pressure sets in, which corresponds to the maximum lift.

7. Method according to claim 1 to 6, wherein if an excess pressure occurs, the pitch angle is adjusted so as to maintain the permissible load.

8. Method according to claim 1 to 6, wherein the first and second pressure measurement (excess pressure and low pressure measurement) are performed multiple times at several measuring points of the rotor blade.

9. Device for controlling the pitch angles of rotor blades on wind power stations, said device comprising means for adjusting the pitch angles wherein at least two pressure-measuring points are disposed on a rotor blade, which pressure-measuring points are connected by means of a measuring and control unit to the means for adjusting the pitch angles.

10. Device according to claim 9, wherein a measuring point contains a channel passing through the shell of the rotor blade, and a pressure transmitter, which is disposed on the inner side of the rotor blade at the internal opening of the respective channel.

11. Device according to claim 9, wherein a measuring point comprises a channel passing through the shell of the rotor blade, a hose connected to said channel and a pressure transmitter disposed at any location in the rotor blade.
